(19) United States
(12) Patent Application Publication
(10) Pub. No.: US 2009/0252668 A1
(43) Pub. Date: Oct. 8, 2009

(54) Methods For Preparing Iron Source Material And Ferrous Oxalate for Lithium Ferrous Phosphate

(75) Inventors: Wenyu Cao, Shenzhen (CN); Shuiyuan Zhang, Shenzhen (CN); Feng Xiao, Shenzhen (CN)

Correspondence Address: Venture Pacific Law, PC, 5201 Great America Parkway, Suite 270, Santa Clara, CA, 95054, US

(73) Assignee: BYD COMPANY LIMITED, Shenzhen (CN)

(21) Appl. No.: 12/176,319

(22) Filed: Jul. 18, 2008

(30) Foreign Application Priority Data
Apr. 7, 2008 (CN) PCT/CN2008/70680

(51) Int. Cl. C01B 25/30

(52) U.S. Cl. 423/306

(57) ABSTRACT

Methods for preparing iron source material and ferrous oxalate for lithium ferrous phosphate are disclosed. One method comprises bringing solution containing ferrite and soluble non-ferrous metal salts in contact with oxalate solution; wherein said method of contact is to allow a flow of the ferrite solution containing ferrite and soluble non-ferrous metal salts to come in contact with a flow of oxalate solution. Another method comprises brings a stream of ferrite solution in contact with a stream of oxalate solution, wherein the flow rates of the ferrite solution and oxalate solution give the resulting slurry a pH of 2-6. The ferrous oxalate particles produces by the methods of the present invention are regularly shaped and have small and evenly distributed diameters. Lithium ferrous phosphate made from iron source material and ferrous oxalate prepared using the methods of the present invention has small particle diameter, homogeneous particle size, good electrical conductivity, and superior electrochemical properties.

### CROSS REFERENCE

This application claims priority from a PCT patent application entitled “A method for preparing iron source used for preparing lithium ferrous phosphate, and a method for preparing lithium ferrous phosphate” filed on Apr. 7, 2008 and having a patent application no. PCT/CN2008/70680. Such application is incorporated herein by reference.

### FIELD OF THE INVENTION

The present invention relates to methods for preparing lithium ferrous phosphate, and, in particular, methods for preparing iron source material and ferrous oxalate for producing lithium ferrous phosphate.

### BACKGROUND

Lithium ion batteries are high voltage, high energy density, light weight, highly reliable, low self-discharge batteries with long cycle lives and no memory effect. As such they are widely used in portable electronics, electric automobiles, and many other fields. Currently the first choice for the active substance in commercial lithium batteries is LiCoO₂ (lithium cobalt oxide), but because cobalt is expensive and toxic, focus has turned to iron based compounds which are inexpensive, have high capacities, and are non-toxic. Regular chrysolite (olive) shaped LiCoO₂ (lithium cobalt oxide) can produce 3.4V (vs. Li/Li⁺). The charge discharge reaction takes place between LiFePO₄ and FePO₄. There is little change in crystal volume and structural stability is maintained. When LiFePO₄ is oxidized into FePO₄ (iron phosphate) its volume decreases by 6.81%. This shrinkage during the charge process makes up for the expansion of the carbon negative electrode, which helps increase the volume efficiency of lithium ion batteries.

One of the biggest disadvantage of lithium ferrous phosphate is that it has poor electrical conductivity. Therefore, in order to increase its electrical conductivity, lithium ferrous phosphate is often prepared using carbon coating or ion doping methods.

Influence of the Mn-doped on the Electrochemical Performance of LiFePO4, authored by Chou Weihua et al. and published in 2003 in Battery Bimonthly volume 33 no. 3, describes using Li₂CO₃, FeC₂O₄.2H₂O, MnCO₃, and (NH₄)₂HPO₄ as raw ingredients, and subjecting them to ball mill mixing and high temperature sintering to prepare manganese doped lithium ferrous phosphate.

Preparation and Performance of LiMgxFe1-xPO4, authored by Wen Yanxuan and published in 2005 in Battery Bimonthly volume 35 no. 1, describes using magnesium acetate, ferrous oxalate, lithium carbonate and diammonium hydrogen phosphate as raw materials, and subjecting them to ball mill mixing and high temperature sintering, to prepare magnesium doped lithium ferrous phosphate. Both of the above mentioned methods use solid state doping, making it difficult to achieve atomic level mixing of the metallic doping elements and elemental iron, and thereby affecting the doping effect.

CN1585168A makes public a method for preparing doped lithium ferrous phosphate to create a LiFe₁₋ₓMₓPO₄ positive electrode material doped with one or two metallic elements from among Cr, Co, Mn, Mg, Ni, and La. This method includes homogeneous mixing of iron, lithium, and a metal M with a phosphorous source according to the atomic ratios Li/Fe+M=1−1.1, Fe/P=1, Fe/M=32-99. A conductive agent is added and mixed evenly, and the resulting mixture is heated in an inert atmosphere at 300-400° C. for 10-18 hours. It is then sintered processed in an inert atmosphere at 650-750° C. for 20-24 hours, then allowed to cool, ball milled, and sifted through a 300 mesh screen to obtain modified lithium ferrous phosphate positive electrode material. The above mentioned methods result in compounds formed by adding doping agents to lithium ferrous phosphate during its preparation, then using high temperature solid state methods. Achieving even distribution of doping ions and iron ions via solid state ion migration is difficult, requiring relatively high temperatures and long sintering times.

Current methods of lithium ferrous phosphate preparation commonly use ferrous oxalate as the source of iron. Because current ferrous oxalate particle diameter is very large, with D₅₀ of 8-10 microns and having a wide particle size distribution, if pre-milling is not done the diameter of the resulting lithium ferrous phosphate particles will be large. Even if pre-milling is done, the particle size of lithium ferrous phosphate that is sintered with lithium and phosphorous compounds is still difficult to control. In addition particle diameters are unevenly distributed and particles are not regularly shaped. Because lithium ferrous phosphate itself has low electrical conductivity, large particle diameter, uneven particle size distribution, and irregularly shaped particles are not conducive in providing good capacitance. Furthermore, The use of doping or coating techniques can to certain extent increase the conductivity of the lithium ferrous phosphate, but they cannot increase the ion conductivity of the material itself.

Effect of Reaction Time on the Composition of Ferrous Oxalate (Sun Yue and Qiao Qingdong; Journal of Liaoning University of Petroleum, Volume 25 No. 4) described a method for preparing ferrous oxalate. This method comprises mixing 18 g ferrous ammonium sulfate with 90 ml of distilled water, then adding 6 ml of 2 moles/liter sulfuric acid to acidify the solution, and heating to dissolve. Next 120 ml of 1 mole/liter oxalate solution is added and the resulting solution is heated until boiling while being stirred continually, until a yellow precipitate forms. The preparation is allowed to sit and the clear liquid is poured off. It is then washed and air dried to yield ferrous oxalate particles. The above mentioned method cannot effectively control the diameter and particle size distribution of the resulting ferrous oxalate particles.

As described above, the particle size of the lithium ferrous phosphate made by sintering this ferrous oxalate is difficult to control, its diameter size distribution is uneven, and its particle shape is not regular. Thus the conductive properties and material capacity of the lithium ferrous phosphate are not effectively improved, and this affects the electrochemical properties of the resulting lithium ion batteries. Moreover, compounds formed by adding doping agents to lithium ferrous phosphate during its preparation then subjecting it to high temperature solid state methods are unable to achieve even distribution of the doping ions and iron ions via solid state ion migration. Lithium ferrous phosphate prepared this way requires relatively high temperatures and long sintering times, and when used in lithium ion batteries results in batteries with poor electrochemical properties.

Therefore, it is desirable to have novel methods for preparing ferrous oxalate and iron material for producing lithium ferrous phosphate.

### SUMMARY OF THE INVENTION

An object of the present invention is to provide methods for preparing iron source material that yields small particles with evenly distributed sizes and regular shapes.

Another object of the present invention is to provide methods for producing lithium ferrous phosphate having evenly distributed doping ions and iron ions, and superior electrochemical properties.

Briefly, methods for preparing iron source material and ferrous oxalate for lithium ferrous phosphate are disclosed. One method comprises bringing solution containing ferrite and soluble non-ferrous metal salts in contact with oxalate solution; wherein said method of contact is to allow a flow of the ferrite solution containing ferrite and soluble non-ferrous metal salts to come in contact with a flow of oxalate solution. Lithium ferrous phosphate made from iron source material prepared using the methods of the present invention has small particle diameter, homogeneous particle size, good electrical conductivity, and superior electrochemical properties. Another method comprises brings a stream of ferrite solution in contact with a stream of oxalate solution, wherein the flow rates of the ferrite liquid solution and oxalate liquid solution give the resulting slurry a pH of 2-6. The ferrous oxalate particles produces by the methods of the present invention are regularly shaped and have small and evenly distributed diameters. As a result the lithium ferrous phosphate made from this ferrous oxalate has small particle diameter, homogenous particle size, evenly distributed carbon, and favorable electrochemical properties.

An advantage of the present invention is that it provides methods for preparing iron source material that yields small particles with evenly distributed sizes and regular shapes.

Another advantage of the present invention is that it provides methods for producing lithium ferrous phosphate having evenly distributed doping ions and iron ions, and superior electrochemical properties.

### DESCRIPTION OF THE FIGURES

FIG. 1 is a SEM image of iron source material prepared according to the present invention.

FIG. 2 is a SEM image of lithium ferrous phosphate made with iron source material prepared according to the present invention.

FIG. 3 is a XRD image of lithium ferrous phosphate made with iron source material prepared according to the present invention.

FIG. 4 is a SEM image of ferrous oxalate prepared using the present invention.

FIG. 5 is a SEM image of lithium ferrous phosphate produced using ferrous oxalate prepared according to the present invention.

FIG. 6 is a XRD image of lithium ferrous phosphate produced using ferrous oxalate prepared according to the present invention.

### DETAILED DESCRIPTION OF THE PREFERRED EMBODIMENTS

The inventor of the present invention noticed that lithium ions are embedded in the FePO₄ structure via a constantly shrinking LiFePO₄/FePO₄ interface. Because the surface area of the FePO₄ interface gradually shrinks, there are not enough lithium ions passing through to maintain a current. This leads to losses from reversible current during heavy-current discharge. If lithium ions can be embedded in a LiFePO₄/FePO₄ interface that has smaller average particle size and evenly distributed particle size, this will increase the effective number of lithium ions, and thereby increase the charge and discharge capacity of the LiFePO₄. Doping of the iron source material with metallic elements during its preparation allows for a more even distribution of doping metal elements and iron element within the lithium ferrous phosphate, and improves performance.

In one aspect the methods of the present invention provide methods for preparing iron source material for lithium ferrous phosphate, wherein this method comprises bringing solution containing ferrite and soluble non-ferrous metal salts in contact with oxalate solution. Said contact method is to allow a flow of liquid solution containing ferrite and soluble non-ferrous metal salts to come in contact with a flow liquid oxalate solution. The flow rates of said solutions cause the resulting slurry to have a pH of 3-6. Said soluble non-ferrous metal salts are selected from one or more soluble salts of group IIA metals, group IIIA metals, group IVA metals, group IB metals, group IIB metals, group IIIB metals, group IVB metals, group VB metals, group VIB metals, group VIIB metals, and non-ferrous group VIII metals.

The present invention also provides methods for preparing lithium ferrous phosphate, comprising sintering a mixture of lithium source, phosphorous source, and iron source materials, and then allowing them to cool. Said iron source materials are prepared according to the methods of the present invention.

Iron source materials for lithium ferrous phosphate prepared by the precipitation method in the present invention have particle diameters of 0.5-8 microns, preferably in the 1-5 micron range. When preparing the iron source, by controlling the flow rates of the liquid solution containing ferrite and soluble non-ferrous metal salts and the liquid oxalate solution and keeping the pH of the resulting mixture within a specified range, the shape and size of the resulting iron source material particles can be controlled. The resulting particles of iron source material are regularly shaped and have small, evenly distributed diameters. More importantly, the metal ions within the non-ferrous metal salts can be evenly distributed within the iron source material. This gives lithium ferrous phosphate products made with iron source material prepared according to this method an even distribution of iron ions and doping metal ions. In addition, the lithium ferrous phosphate particles themselves have small diameters, homogeneous particle size, increased electrical conductivity, and superior electrochemical properties.

The present invention provides a method of producing ferrous oxalate for use in lithium ferrous phosphate that comprises bringing ferrite solution in contact with oxalate solution. Said method of contact involves bringing a stream of ferrite liquid solution in contact with a stream of oxalate liquid solution. The flow rates of the ferrite liquid solution and oxalate liquid solution give the resulting slurry a pH of 2-6.

When using the present invention's precipitation method to prepare ferrous oxalate, the shape and size of ferrous oxalate particles can be achieved by controlling the flow speeds of the ferrite liquid solution and oxalate liquid solution and maintaining the pH of the resulting slurry within a given range. This will create ferrous oxalate particles with regular shapes, relatively small diameters, and an even size distribution. Lithium ferrous phosphate produced using this ferrous oxalate will have small particle diameter, homogeneous particle size, evenly distributed carbon, and good electrochemical properties.

The methods of the present invention comprise bringing solution containing ferrite and soluble non-ferrous metal salts in contact with oxalate solution, said contact method is to allow a flow of liquid solution containing ferrite and soluble non-ferrous metal salts to come in contact with a flow liquid oxalate solution. The flow rates of said solutions cause the resulting slurry to have a pH of 3-6, preferably 4-5. Said soluble non-ferrous metal salts are selected from one or more soluble salts of group IIA metals, group IIIA metals, group IVA metals, group IB metals, group IIB metals, group IIIB metals, group IVB metals, group VB metals, group VIB metals, group VIIB metals, and non-ferrous group VIII metals.

To more accurately control the diameter of the resulting iron source material, preferably said liquid solution containing ferrite and soluble non-ferrous metal salts has a flow rate of 1-10 liters/hour, preferably 1-5 liters/hour. The flow rate of said liquid oxalate solution gives the resulting slurry a pH of 3-6, preferably 4-5;

To ensure that the diameters of the resulting iron source material particles are small and evenly distributed, the flow rate of the liquid solution containing ferrite and soluble non-ferrous metal salts and the flow rate of the liquid oxalate solution are even.

To ensure that the two solutions come into full contact and to prevent excessively high concentrations in any one area, as well as to control the particle shape of the resulting iron source material, the liquid solution containing ferrite and soluble non-ferrous metal salts and liquid oxalate solution preferably come into contact during mixing, with the liquid solution containing ferrite and soluble non-ferrous metal salts and liquid oxalate solution flowing into water at the same time. The two liquid solutions preferably come in contact inside a mixer, with water equal to at least 1/10 of the mixer's capacity, preferably ⅕-½ of its capacity.

Said liquid solution containing ferrite and soluble non-ferrous metal salts and liquid oxalate solution are both aqueous solutions. Said ferrite is selected from among one or more of ferrous sulfate, ferrous chloride, and ferrous acetate. Said soluble non-ferrous metal salts are selected from one or more soluble sulfate, nitrates, chlorides of group IIA metals, group IIIA metals, group IVA metals, group IB metals, group IIB metals, group IIIB metals, group IVB metals, group VB metals, group VIB metals, group VIIB metals, or group VIII non ferrous metals; preferably one or more of magnesium sulfate, aluminum sulfate, zirconium nitrate, manganese sulfate, cobalt sulfate, nickel sulfate, zinc sulfate, magnesium nitrate, aluminum nitrate, magnesium chloride, aluminum chloride, manganous chloride, cobaltous chloride, nickelous chloride, calcium chloride, barium chloride, strontium chloride, stannous chloride, or lanthanum nitrate. Said oxalate is selected from among one or more of sodium oxalate, kalium oxalate, ammonium oxalate, or lithium oxalate.

Said solution containing ferrite and soluble non-ferrous metal salts has an overall ferrous ion and soluble non-ferrous metal salt concentration of 0.5-5 moles/liter. In said mixture the molar ratio of ferrous ions and non ferrous metal ions is 1:0.005-0.25; the concentration of oxalate ions in said oxalate solution is 0.1-5 moles/liter.

The methods of the present invention also comprise filtering the slurry produced by mixing the liquid solution containing ferrite and soluble non-ferrous metal salts and the liquid oxalate solution, and drying to obtain the resulting solids. The methods and conditions used to dry the solids are well known within the field and include natural drying, drum drying, vacuum drying etc. Drying time is 0.5-10 hours and drying temperature is room temperature −100° C.

Under preferred conditions, in order to produce a more complete reaction, before filtering this method also comprises aging the slurry produced by mixing the liquid solution containing ferrite and soluble non-ferrous metal salts and liquid oxalate solution. Aging temperature is 40-90° C., and aging time is 1-10 hours.

After filtering the slurry produced by the mixing of the liquid solution containing ferrite and soluble non-ferrous metal salts and liquid oxalate solution and before drying, this method also comprises washing of the solid products. Washing can be done with water or organic solvents. There are no special limitations on washing time or repetitions, provided any solution remaining on the solids is washed clean.

The iron source produced the methods of this invention Fe₁₋ₓMₓ(C₂O₄)_{y}.2H₂O (where x is 0.005-0.2, and y is 1-1.3) has particle diameters of 0.5-8 microns, preferably 0.5-5 microns, and median particle diameter D₅₀ of 1-3 microns, preferably 1.5-2 microns.

The present invention provides methods for preparing lithium ferrous phosphate; these methods comprise sintering a mixture of lithium source, phosphorous source and iron source materials, then cooling the results of the sintering; wherein the iron source materials are prepared according to the methods of the present invention.

The lithium source may be selected from one or more common lithium compounds used to prepare lithium ferrous phosphate, including LiOH, Li₂CO₃, CH₃COOLi, LiNO₃, Li₃PO₄, Li₂HPO₄, and LiH₂PO₄, preferably Li₂CO₃ and/or Li₂HPO₄. Because Li₂HPO₄ supplies both lithium and phosphate ions, Li₂HPO₄ is preferred;

The phosphorous source may be selected from one or more common phosphorous compounds used to prepare lithium ferrous phosphate, including (NH₄)₃PO₄, (NH₄)₂HPO₄, NH₄H₂PO₄, Li₃PO₄, Li₂HPO₄ and LiH₂PO₄.

Said lithium source, phosphorous source and iron source material prepared according to the methods of the present invention need only have lithium:iron and non-ferrous metal:phosphorous molar ratios of(1-1.07) 1:1.

According to the method of preparing lithium ferrous phosphate provided in the present invention, said lithium source, phosphorous source, and iron source materials are mixed with additives, which act as a carbon source, and help increase the electrical conductivity of the lithium ferrous phosphate. The types and usage amounts of these additives are well known within the field. The additive may be one or more organic materials that can undergo anaerobic decomposition at low temperatures including glucose, sucrose, citric acid etc. These organic compounds undergo anaerobic decomposition at relatively low temperatures, creating nanometer scale carbon that is relatively highly active. They are also reducible at lower temperatures and inhibit the oxidation of ferrous irons, while also inhibiting the formation of large particles.

Preferably, in order to mix the reagents more completely, before sintering milling is done as well, preferably ball milling, to mix a mixture having lithium compounds, phosphorous compounds, ferrous oxalate, and an additive having self-selective characteristics. The ball-milling methods, such as mixing dispersants with the above mentioned compounds then ball-milling, are well known within in the field. One or more common dispersants may be used including methanol, ethanol, and acetone.

When sintering, in order to ensure complete reaction of the lithium source materials, phosphorous source materials, and iron source materials, particle formation preferably takes place after the ball-milled mixture has been dried. Particle formation methods and conditions are well known within the field.

Sintering methods and conditions are well known within the field. Sintering is commonly a two stage process, the goal during the first stage being to allow large particles iron source materials, such as ferrous oxalate, to decompose into small particles, then in the second stage to produce lithium ferrous phosphate crystals. Under normal conditions, the first sage of sintering is done at 300-500° C., preferably 350-450° C., for a period of 4-10 hours, preferably 6-8 hours. The second stage of sintering is done at 600-800° C., preferably 650-750° C., for a period of 8-30 hours, preferably 12-20 hours. During a two stage sintering process in order to achieve lithium ferrous phosphate particles of evenly distributed size, it is preferable to grind the products of the first stage before the second stage is begun. Grinding may be done by way of the ball milling process described above, which will not be further described here.

According to the present invention, because the iron source material of the present invention is ferrous oxalate produced by the methods described above, which has small and evenly distributed particle size and contains doping metals, during mixing the ferrous oxalate mixes evenly with other ingredients. During high temperature solid phase reactions the distances between the various kinds of ions shrink due to solid phase diffusion. Because of this, one phase of sintering is sufficient to produce the desired results. The sintering temperature during this phase is 650-850° C., preferably 700-800° C., and the sintering time is 8-40 hours, preferably 10-20 hours.

To prevent oxidation of ferrous oxalate containing doping metals during the sintering process, sintering is preferably done in an inert or reduction atmosphere. Inert or reduction atmosphere refers to a gas or gaseous compound mixture that does not react with the reactants or products, including one or more of the following: hydrogen, nitrogen, carbon monoxide, ammonia decomposed gas or a noble gas. This inert or reduction atmosphere can be static, or preferably, have a gas flow of 2-50 liters/minute.

The present invention is further described below by the various embodiments.

### Embodiment 1

This embodiment illustrates the methods provided in the present invention of preparing iron source materials and producing lithium ferrous phosphate from said iron source materials.

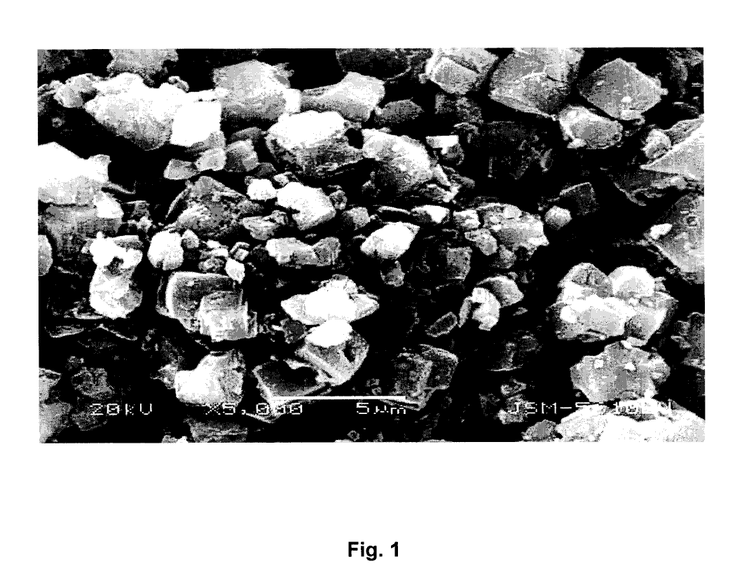

(1) Dissolve 9.7 moles ferrous sulfate heptahydrate and 0.3 moles magnesium sulfate heptahydrate in deionized water to form an aqueous ferrous sulfate solution with metal ion concentration of 1 mole/liter (the ratio of ferrous ions and magnesium ions in the solution is 97:3). Dissolve 10 moles of kalium oxalate in deionized water to form a kalium oxalate solution with oxalic acid ion concentration of 1 mole/liter. Pour 6 liters of deionized water into a 30 liter reaction vessel. Then use a metering pump to pump a homogeneous flow of the above mentioned ferrous sulfate and magnesium sulfate solutions into the vessel, while at the same time using a servo pump to pump a homogeneous flow of the above mentioned kalium oxalate into the vessel. The flow rate of the liquid solution containing ferrite and soluble non-ferrous metal salts is 2 liters/hour. The flow rate of the oxalate solution gives the resulting slurry a pH of 4. Stop the reaction 5 hours after it starts, and allow the slurry in the reaction vessel to age for 4 hours. Next filter out the solids and rinse them with water 3 times, then wash with ethanol one time. Completely rinse the solution off the solids then filter and dry for 5 hours in a vacuum at 80° C. to produce iron source Fe_{0.97}Mg_{0.03}C₂O₄.2H₂O material with a median particle diameter D₅₀ of 2.0 micron and particle diameter 0.8-5 micron. An SEM image of this iron source material taken with a Japanese company (Shimadzu) SSX-550 scanning electron microscope is shown in FIG. 1.

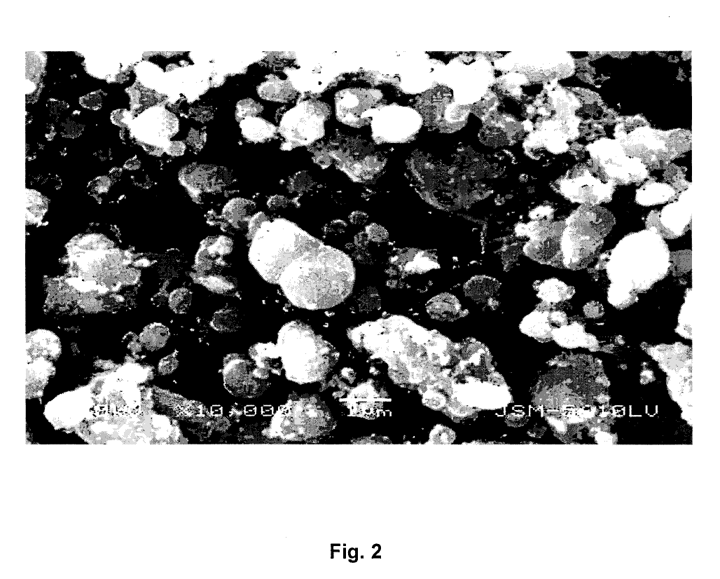

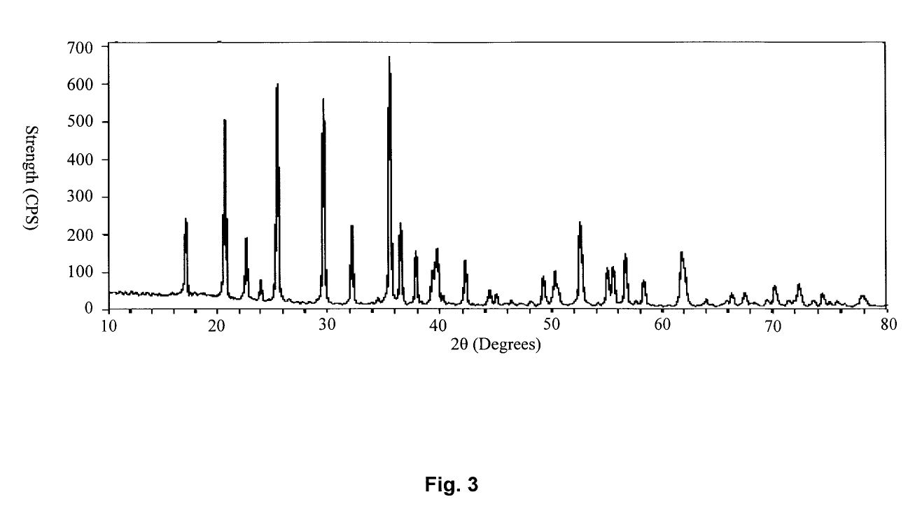

(2) Using a Li:Fe: non-ferrous metal ratio of 1:1:1, weigh out 370 grams of lithium carbonate, 1789 g of the iron source material obtained in step (1), and 1150 g of ammonium dihydrogen phosphate. Using a C:Fe ratio of 0.5, add 165 g of glucose as a carbon source. Place the above mentioned lithium carbonate, iron source material, ammonium dihydrogen phosphate and glucose in a ball-mill, and add 5000 ml anhydrous ethanol as a dispersant. Mill for 0.5 hours. Use a spray granulator to dry and granulate the resulting mixture. Place the powder described above into a corundum pot and sinter in a high temperature oven with an argon atmosphere flowing at 20 liters/minute. Sintering temperature is 700° C., and sintering time 20 hours. When the powder cools off a jet pulverizer is used to obtain magnesium doped lithium ferrous phosphate particles. A SEM of this magnesium doped lithium ferrous phosphate taken with a Japanese company (Shimadzu) manufactured SSX-550 scanning electron microscope is shown in FIG. 2. A powder diffraction pattern made with a Rigaku D/MAX-2200/PC X-ray diffractometer is shown in FIG. 3.

### Embodiment 2

This embodiment illustrates the methods provided in the present invention of preparing iron source materials and producing lithium ferrous phosphate from said iron source materials.

Iron source material and lithium ferrous phosphate are produced according to embodiment 1, the difference being that when preparing the iron source the liquid solution containing ferrite and soluble non-ferrous metal salts is prepared by dissolving 9.9 moles ferrous sulfate heptahydrate and 0.1 moles zirconium nitrate pentahydrate in deionized water, forming a liquid solution with 1 mole/liter of metal ions (the ratio of ferrous ions and zirconium ions in the solution is 99:1). The oxalate liquid solution is prepared by mixing 10 moles sodium oxalate in water to produce a solution with oxalate ion concentration of 1 mole/liter. Said liquid solution containing ferrite and soluble non-ferrous metal salts has a flow rate of 3.5 liters/hour, and the flow rate of said liquid oxalate solution gives the resulting slurry a pH of 5. Other conditions and procedures are identical to embodiment 1. When the reaction is complete, the resulting iron source material Fe_{0.99}Zr_{0.01}(C₂O₄)_{1.01}.2H₂O particles have diameters 0.9-4 microns and median diameter D₅₀ of 1.5 microns. When preparing lithium ferrous phosphate, the iron source is Fe_{0.99}Zr_{0.01}(C₂O₄)_{1.01}.2H₂O as prepared in embodiment 2.

### Embodiment 3

This embodiment illustrates the methods provided in the present invention of preparing iron source materials and producing lithium ferrous phosphate from said iron source materials.

Iron source material and lithium ferrous phosphate are produced according to embodiment 1, the difference being that when preparing the iron source, the liquid solution containing ferrite and soluble non-ferrous metal salts is prepared by dissolving 0.8 moles ferrous sulfate and 0.2 moles manganous sulfate in deionized water, forming a liquid solution with metal ion concentration of 0.5 mole/liter (the ratio of ferrous ions and manganese ions in the solution is 4:1). The oxalate is prepared by dissolving 10 moles of kalium oxalate in deionized water to create a kalium liquid oxalate solution with oxalate ion concentration of 0.5 moles/liter. The liquid solution containing ferrite and soluble non-ferrous metal salts has a flow rate of 5 liters/hour, the flow rate of said liquid oxalate solution gives the resulting slurry a pH of 3. Other conditions and procedures are identical to embodiment 1. When the reaction is complete, the resulting iron source material Fe_{0.8}Mn_{0.2}C₂O₄.2H₂O particles have diameters 1-6 microns and median diameter D₅₀ of 2.2 microns.

When preparing lithium ferrous phosphate, the difference is that 175 grams of citric acid is added in to ensure a C:Fe molar ratio of 0.5. The iron source material is Fe_{0.8}Mn_{0.2}C₂O₄.2H₂O as prepared in embodiment 3. Sintering is performed where sintering temperature is 800° C., and sintering time is 15 hours;

### Embodiment 4

This embodiment illustrates the methods provided in the present invention of preparing iron source materials and producing lithium ferrous phosphate from said iron source materials.

Iron source material and lithium ferrous phosphate are produced according to embodiment 1, the difference being that when preparing the iron source, the liquid solution containing ferrite and soluble non-ferrous metal salts is prepared by dissolving 9.95 moles ferrous chloride and 0.05 moles stannous chloride in deionized water, forming a liquid solution with 2 mole/liter of metal ions (the ratio of ferrous ions and tin ions in the solution is 199:10). The oxalate is prepared by dissolving 5 moles of kalium oxalate and 5 moles sodium oxalate in deionized water, to create an oxalate solution with oxalic acid ion concentration of 2 moles/liter. Before the reaction begins, 10 liters of deionized water are poured into a 30 liter reaction vessel, then the liquid solution containing ferrite and non ferrous metal salts and the liquid solution of ferrous oxalate are pumped into the reaction vessel. Said liquid solution containing ferrite and soluble non-ferrous metal salts has a flow rate of 1 liters/hour, and the flow rate of said liquid oxalate solution gives the resulting slurry a pH of 6. After reacting for 10 hours, the reaction is stopped and the resulting slurry is aged for 5 hours. When the reaction is complete, the resulting particles of iron source material Fe_{0.995}Sn_{0.005}C₂O₄.2H₂O have diameters 0.7-4.6 microns and median diameters D₅₀ of 1.3 microns.

When preparing lithium ferrous phosphate, the difference is that a lithium:iron and non-ferrous metal:phosphorous molar ratio of is 1:1:1 is used, giving 831.2 grams lithium dihydrogen phosphate and 1441.7 grams of the iron source material produced in step (1). In addition, 114.1 grams of sucrose as a carbon source is added to ensure a C:Fe molar ratio of 0.5, and the iron source material used is the Fe_{0.995}Sn_{0.005}C₂O₄.2H₂O obtained in embodiment 4.

### Embodiment 5

This embodiment illustrates the methods provided in the present invention of preparing iron source materials and producing lithium ferrous phosphate from said iron source materials.

Iron source material and lithium ferrous phosphate are produced according to embodiment 1, the difference being that when preparing the iron source, the liquid solution containing ferrite and soluble non-ferrous metal salts is prepared by dissolving 0.98 moles ferrous sulfate and 0.02 moles aluminum sulfate octadecahydrate in deionized water, forming a liquid solution with 1.5 mole/liter of metal ions (the ratio of ferrous ions and aluminum ions in the solution is 98:2). The oxalate is prepared by dissolving 5 moles of kalium oxalate and 5 moles sodium oxalate in deionized water, to create an oxalate solution with oxalic acid ion concentration of 1.5 moles/liter. Said liquid solution containing ferrite and soluble non-ferrous metal salts has a flow rate of 1.5 liters/hour, and the flow rate of said liquid oxalate solution gives the resulting slurry a pH of 4.5. Other conditions and procedures are identical to Example 1. When the reaction is complete, the resulting particles of iron source material Fe_{0.98}Al_{0.02}(C₂O₄)_{1.01}.2H₂O have diameters 1.0-6.0 microns and median diameters D₅₀ of 2.5 microns. When preparing lithium ferrous phosphate the iron source material used is the Fe_{0.98}Al_{0.02}(C₂O₄)_{1.01}.2H₂O obtained in embodiment 5.

### Embodiment 6

This embodiment illustrates the methods provided in the present invention of preparing iron source materials and producing lithium ferrous phosphate from said iron source materials.

Iron source material and lithium ferrous phosphate are produced according to embodiment 1, the difference being that when preparing the iron source, the liquid solution containing ferrite and soluble non-ferrous metal salts is prepared by dissolving 8.5 moles ferrous sulfate heptahydrate and 1.5 moles cobaltous sulfate hexahydrate in deionized water, forming a liquid solution with 1 mole/liter of metal ions (the ratio of ferrous ions and cobalt ions in the solution is 85:15). The oxalate liquid solution is prepared by mixing 10 moles sodium oxalate in water to produce a solution with oxalic acid ion concentration of 1 mole/liter. The liquid solution containing ferrite and soluble non-ferrous metal salts has a flow rate of 3 liters/hour, and the flow rate of said liquid oxalate solution gives the resulting slurry a pH of 4. Other conditions and procedures are identical to embodiment 1. When the reaction is complete, the resulting particles of iron source material Fe_{0.85}Co_{0.15}C₂O₄.2H₂O have diameters 0.7-5.5 microns and median diameters D₅₀ of 1.2 microns. When preparing lithium ferrous phosphate the iron source material used is the Fe_{0.85}Co_{0.15}C₂O₄.2H₂O obtained in embodiment 6.

### Embodiment 7

This embodiment illustrates the methods provided in the present invention of preparing iron source materials and producing lithium ferrous phosphate from said iron source materials.

Iron source material and lithium ferrous phosphate are produced according to embodiment 1, the difference being that when preparing the iron source, the liquid solution containing ferrite and soluble non-ferrous metal salts is prepared by dissolving 9 moles ferrous sulfate heptahydrate and 1 mole nickelous sulfate hexahydrate in deionized water, forming a liquid solution with 1 mole/liter of metal ions (the ratio of ferrous ions and nickel ions in the solution is 9:1). The oxalate liquid solution is prepared by mixing 10 moles sodium oxalate in water to produce a solution with oxalate ion concentration of 1 mole/liter. Deionized water is not added to the reaction vessel before hand. Said liquid solution containing ferrite and soluble non-ferrous metal salts has a flow rate of 1 liter/hour and the flow rate of said liquid oxalate solution gives the resulting slurry a pH of 3.5. Other conditions and procedures are identical to embodiment 1. When the reaction is complete, the resulting particles of iron source material Fe_{0.9}Ni_{0.1}C₂O₄.2H₂O have diameters 0.9-5.4 microns and median diameter D₅₀ of 2.3 microns. When preparing lithium ferrous phosphate the iron source material used is the Fe_{0.9}Ni_{0.1}C₂O₄.2H₂O obtained in embodiment 7.

### Embodiment 8

This embodiment illustrates the methods provided in the present invention of preparing iron source materials and producing lithium ferrous phosphate from said iron source materials.

Iron source material and lithium ferrous phosphate are produced according to embodiment 1, the difference being that when preparing the iron source, the liquid solution containing ferrite and soluble non-ferrous metal salts is prepared by dissolving 9 moles ferrous sulfate heptahydrate, 0.5 moles manganous sulfate hydrate and 0.5 moles magnesium sulfate heptahydrate in deionized water, forming a liquid solution with 3 mole/liter of metal ions (the ratio of ferrous ions, manganese ions and magnesium, ions in the solution is 18:1:1). The oxalate liquid solution is prepared by mixing 10 moles sodium oxalate in water to produce a solution with oxalic acid ion concentration of 3 mole/liter. Said liquid solution containing ferrite and soluble non-ferrous metal salts has a flow rate of 2.5 liters/hour, and the flow rate of said liquid oxalate solution gives the resulting slurry a pH of 5. Other conditions and procedures are identical to embodiment 1. When the reaction is complete, the resulting particles of iron source material Fe_{0.9}Mn_{0.05}Mg_{0.05}C₂O₄.2H₂O have diameters 0.4-6 microns and median diameter D₅₀ of 1.8 microns. When preparing the lithium ferrous phosphate the iron source material used is the Fe_{0.9}Mn_{0.05}Mg_{0.05}C₂O₄.2H₂O obtained in embodiment 8.

### Embodiment 9

This embodiment illustrates the methods provided in the present invention of preparing iron source materials and producing lithium ferrous phosphate from said iron source materials.

Iron source material and lithium ferrous phosphate are produced according to embodiment 4, the difference being that when preparing the lithium ferrous phosphate, two stage sintering process is used. First the mixed powder particles are sintered in a high temperature oven with an argon atmosphere moving at 20 liters/minute. Sintering temperature is 350° C., and sintering time is 8 hours. When the powder has cooled it is milled in a ball mill for 0.5 hours, then once again placed in a corundum pot and sintered for a second time in a high temperature oven with an argon atmosphere moving at 20 liters/minute. Sintering temperature is 750° C., and sintering time is 20 hours. When the powder has cooled it is jet pulverized to prepare lithium ferrous phosphate particles.

### Comparative Embodiment 1

This comparative embodiment provides an alternate method of preparing iron source material and preparing lithium ferrous phosphate from iron source material.

According to the publicly known method for preparing ferrous oxalate given in Effect of Reaction Time on the Composition of Ferrous Oxalate (Sun Yue and Qiao Qingdong; Journal of Liaoning University of Petroleum, Volume 25 No. 4), 18 g of ferrous ammonium sulfate are mixed with 90 ml of distilled water to obtain an aqueous ferrous ammonium sulfate solution. Then 6 ml of 2 mole/liter sulfuric acid solution is added to acidify the solution, which is heated to dissolve. Next 120 ml of 1 mole/liter oxalate solution is added to the above solution, and the resulting solution is heated for 80 minutes while being mixed. The solution is allowed to stand, the clear liquid is poured off, and the yellow precipitate is washed with water, filtered, and dried. The result is ferrous oxalate dihydrate with median particle diameter D₅₀ of 11 microns.

Using a Li:Fe:Mg:P ratio of 1:0.97:0.03:1, weigh out 370 grams of lithium carbonate, 1745 g of the ferrous oxalate obtained above, 12 grams magnesium oxide and 1150 g of ammonium dihydrogen phosphate. Using the C:(Fe +Mg) ratio of 0.5, add 165 g of glucose as a carbon source. Place the above mentioned lithium carbonate, ferrous oxalate, ammonium dihydrogen phosphate and glucose in a ball-mill, and add 5000 ml anhydrous ethanol as a dispersant. Mill for 0.5 hours. Use a spray granulator to dry and granulate the resulting mixture. Place the resulting powder into a corundum pot and sinter for a second time in a high temperature oven with an argon atmosphere flowing at 20 liters/minute. Sintering temperature is 750° C., and sintering time 20 hours. When the powder cools off a jet pulverizer is used to obtain magnesium doped lithium ferrous phosphate particles.

### Comparative Embodiment 2

This comparative embodiment illustrates an alternative method of preparing lithium ferrous phosphate from ferrous oxalate.

Magnesium doped lithium ferrous phosphate is prepared according to the methods in Comparative Embodiment 1, the difference being, the ferrous oxalate is purchased on the market (made by Shanghai Dafeng, particle diameter 0.5-300 microns, D₅₀ of 11.5 microns).

### Comparative Embodiment 3

This comparative embodiment provides alternate methods of preparing iron source material and preparing lithium ferrous phosphate from iron source material.

Iron source material and lithium ferrous phosphate are produced according to embodiment 1, the difference being that when preparing the iron source, the liquid solution containing ferrite and soluble non-ferrous metal salts has a flow speed of 5 liters/hour, and the flow rate of said liquid oxalate solution gives the resulting slurry a pH of 1. After reacting for 2 hours, the reaction is stopped and no ageing is done. The results are directly filtered, and the solids are washed and dried in a vacuum at 80° C. for 5 hours, the resulting particles of iron source material Fe_{0.97}Mg_{0.03}C₂O₄.2H₂O have diameters 0.3-25 microns and median diameter D₅₀ of 13 microns. When preparing the lithium ferrous phosphate, and the iron source material used is the Fe_{0.97}Mg_{0.03}C₂O₄.2H₂O obtained in Comparative embodiment 3.

### Comparative embodiment 4

This comparative embodiment provides alternate methods of preparing iron source material and preparing lithium ferrous phosphate from iron source material.

Iron source material and lithium ferrous phosphate are produced according to embodiment 1, the difference being that controlling the flow speeds of the liquid solution containing ferrite and soluble non-ferrous metal salts and the liquid oxalate solution cause the resulting slurry to have a pH of 8. After reacting for 5 hours the reaction is stopped. The resulting solids are aged, filtered, and washed, and then dried in a vacuum at 80° C. for 5 hours. The resulting particles of iron source material Fe_{0.97}Mg_{0.03}C₂O₄.2H₂O have diameters 3-30 microns and median diameter D₅₀ of 18 microns. When preparing the lithium ferrous phosphate, and the iron source material used is the Fe_{0.97}Mg_{0.03}C₂O₄.2H₂O obtained in Comparative embodiment 4.

### Embodiment 10-18

The embodiments below illustrate tested properties of batteries made using lithium ferrous phosphate prepared according to the present invention as a positive electrode active substance.

### (1) Battery Preparation

### Positive Electrode Preparation

Mix 100 g of positive electrode active ingredient LiFePO₄ as prepared from embodiments 1-9, 3 g of adhesive PVDF, and 2 g of conductive agent acetylene black into 50 g of n-methyl-2-pyrrolidone. Then mix in a vacuum mixer to form homogenous positive electrode substance.

Evenly paste this positive electrode substance onto both sides of 20 micron thick aluminum foil, so that single surface density is 12mg/cm2. Heat dry at 150° C., roll, and cut a 540×43.5 mm positive electrode containing 5.63 g of active substance LiFePO₄.

### Negative Electrode Preparation

Combine 100 g of negative electrode active ingredient natural graphite, 3 g of adhesive PVDF, and 3 g of conductive material carbon black into 100 g n-methyl-2-pyrrolidone, and mix in a vacuum to create the negative electrode material.

Evenly paste this negative electrode substance onto both sides of 12 micron thick copper foil, so that single surface density is 5mg/cm2. Heat dry at 90° C., roll, and cut a 500×44 mm negative electrode containing 2.6 g of active substance natural graphite.

Battery Assembly

Wind the positive and negative electrodes and the polypropylene membrane into a rectangle-shaped lithium ion battery core, then dissolve 1 mole/liter LiPF₆ in a EC/EMC/DEC=1:1:1 solvent mixture to produce an non-aqueous electrolyte solution. Pour 3.8 g/Ah of this electrolyte solution into the batteries aluminum shells and seal to create lithium ion secondary batteries A1-A9.

### Testing of Battery Properties

Lithium ion batteries A1-A9 described above are placed in a testing cabinet and charged using 15 milliamp/hour constant current and constant voltages for 2.5 hours. Maximum charge is 3.85 volts. After allowing the batteries to sit for 20 minutes they are discharged at a rate of 15 mAh/g from 3.85 to 2.5 volts. The first discharge capacity of each battery is recorded and the above described cycle is repeated 20 times. The discharge capacity is then recorded again, and the following formulae are used to compute the specific energy and battery charge retention:

Specific energy=first discharge capacity (mAh)/positive electrode substance mass (g)

Charge retention=(discharge capacity after 20 cycles/first discharge capacity)×100%

The results are given in Table 1.

### Comparative Embodiment 5-8

The following comparative examples illustrate properties testing of batteries made with reference positive electrode active substance lithium ferrous phosphate

Batteries AC1-AC4 are prepared according to embodiment 10-18 and the batteries initial discharge capacity and cycling properties are tested. In addition the batteries specific energy is tested before and after cycling, the difference being that the positive electrode active substance is the lithium ferrous phosphate obtained in comparative embodiment 1-4.

The results are given in Table 1 below.

TABLE 1

| | | Initial | | |
|---|---|---|---|---|
| | | Discharge | Specific | |
| | | Specific | Energy after | Charge |
| Embodiment | Battery | Energy | 20 Cycles | Retention |
| No. | No. | (mAh/g) | (mAh/g) | (%) |
| Em. 10 | A1 | 140.2 | 139.5 | 99.5 |
| Comp. Em. 5 | AC1 | 131.7 | 114.6 | 87.0 |
| Comp. Em. 6 | AC2 | 130.6 | 119.3 | 91.3 |
| Comp. Em. 7 | AC3 | 129.2 | 121.1 | 93.7 |
| Comp. Em. 8 | AC4 | 131.6 | 120.2 | 91.3 |
| Em. 11 | A2 | 137.5 | 135.8 | 98.8 |
| Em. 12 | A3 | 136.4 | 134.8 | 98.8 |
| Em. 3 | A4 | 145.6 | 143.2 | 98.4 |
| Em. 14 | A5 | 148.6 | 143.0 | 96.2 |
| Em. 15 | A6 | 149.1 | 143.9 | 96.5 |
| Em. 16 | A7 | 139.7 | 137.8 | 98.6 |
| Em. 17 | A8 | 135.8 | 133.0 | 97.9 |
| Em. 18 | A9 | 142.8 | 141.6 | 99.2 |

Using the method of embodiment 1 as an example, FIG. 1 is a 5,000× magnification scanning electron microscope image of iron source material doped ferrous oxalate prepared according to the methods of the present invention. The image shows that the doped ferrous oxalate crystal particles have homogeneous particle size, evenly distributed diameters, and that most diameters are in the 1-5 micron range.

FIG. 2 is a 10,000 magnification SEM image of doped lithium ferrous phosphate made iron source materials prepared according to the methods of the present invention. Said doped lithium ferrous phosphate particles have small diameters and homogenous particle size, with most diameters between 0.8 and 1.5 microns.

FIG. 3 shows that the above described lithium ferrous phosphate has standard chrysolite structure with no impurities.

The data in Table 1 shows that compared to reference batteries in which the positive electrode active substance is made with currently available ferrous oxalate, and in which the lithium ferrous phosphate is doped with metal compounds during its preparation, batteries whose lithium ferrous phosphate is made from metal doped ferrous oxalate prepared according to the methods of the present invention have significantly higher specific energies both on initial discharge and performance after 20 cycles. These batteries also have charge retention of 96% or more after 20 cycles. This indicates that these batteries possess favorable features, and therefore that the positive electrode substance lithium ferrous phosphate prepared according to the present invention has evenly distributed doping metals, and has superior electrochemical properties.

### Alternate Embodiments of the Present Invention

According to the methods of the present invention, these methods comprise bringing ferrite solution in contact with oxalate solution. Said method of contact brings a stream ferrite liquid solution in contact with a stream of oxalate liquid solution. The flow rates of the ferrite liquid solution and oxalate liquid solution give the resulting slurry a pH of 2-6, preferably 3-4.

In order to control the particle size of the resulting ferrous oxalate more precisely, under preferred conditions the flow speed of the ferrite liquid solution is 1-10 liters/hour, preferably 1-5 liters/hour; and the flow speed of the oxalate gives the resulting mixture a pH of 2-6, preferably 3-4.

To ensure that the resulting ferrous oxalate has small and evenly distributed particle size, the flow speeds of the ferrite liquid solution and oxalate liquid solution are even.

To ensure that the two solutions come into full contact and to prevent excessively high concentrations in any one area, as well as to control the particle shape of the resulting ferrous oxalate, the ferrite liquid solution and oxalate liquid solution preferably come into contact during mixing, with the ferrite liquid solution and oxalate liquid solution flowing into water at the same time. The two liquid solutions preferably come in contact inside a mixer, with water equal to at least 1/10 of the mixer's capacity, preferably ⅕-½ of its capacity.

Said ferrite solution is an aqueous solution. This ferrite solution has an iron ion concentration of 0.1-5 moles/liter. The ferrite is selected from one or more of the following: ferrous sulfate, ferrous chloride, or ferrous acetate.

Said oxalate solution is an aqueous solution. This oxalate solution has oxalic acid ion concentration of 0.1-5 moles/liter. Oxalate is selected from one or more of the following: sodium oxalate, kalium oxalate, ammonium oxalate, or lithium oxalate.

The method covered in the present invention also comprises filtering the solid substances produced after the ferrite solution and oxalate solution have been mixed and dried. The methods and conditions relating to drying solids are well known within the field, and include natural drying, drum drying, vacuum drying etc. Drying time can be 0.5-10 hours, and drying temperature can be room temperature −100° C.

Under preferred conditions, in order to produce a more complete reaction, before filtering, this method also comprises aging the slurry produced by the mixture of ferrite solution and oxalate solution. Ageing temperature is 40-90° C., and ageing time is 1-10 hours.

After filtering the slurry produced by the mixing of ferrite solution and oxalate solution, and before drying, this method also comprises washing of the solid products. Washing can be done with water or organic solvents. There are no special limitations on washing time or repetitions, provided any solution remaining on the solids is washed clean.

The median particle diameter of ferrous oxalate particles produced with the methods of the present invention is 1-3 microns, preferably 1.5-2.5 microns. The particle sizes of the ferrous oxalate have a normal distribution.

The present invention also provides a method of preparing lithium ferrous phosphate which comprises mixing then sintering lithium compounds, phosphorus compounds, and ferrous oxalate, wherein said ferrous oxalate provides the ferrous oxalate for the present invention.

One or several conventional lithium compounds may be used including lithium bydroxide, lithium carbonate, lithium acetate, lithium nitrate, lithium phosphate, lithium hydrogen phosphate, and lithium dihydrogen phosphate. Lithium carbonate or lithium dihydrogen phosphate is preferred because lithium dihydrogen phosphate also provides lithium and phosphoric acid radicals. Lithium dihydrogen phosphate is therefore preferred.

One or several common phosphorous compounds may be used, including ammonium phosphate, ammonium hydrogen phosphate, ammonium dihydrogen phosphate,lithium phosphate, lithium hydrogen phosphate and lithium dihydrogen phosphate.

The lithium compounds, phosphorous compounds and ferrous oxalate as described in the present invention merely need to maintain a Li:P:Fe ratio of (0.98-1.07) 1:1.

The lithium ferrous phosphate preparation method in the present invention comprises mixing additives with lithium compounds, phosphorous compounds and ferrous oxalate. The additives are the carbon source, which helps increase the electrical conductivity of the lithium ferrous phosphate. The additive may be one or more of the following organic materials that can undergo anaerobic decomposition at low temperatures: glucose, sucrose, citric acid etc. These organic compounds undergo anaerobic decomposition at relatively low temperatures, creating nanometer scale carbon that is relatively highly active. It also is reducible at lower temperatures and inhibits the oxidation of ferrous irons, while also inhibiting the formation of large particles.

Preferably, in order to mix the reagents more completely, before sintering, milling is done as well, preferably ball milling, to mix a mixture having lithium compounds, phosphorous compounds, ferrous oxalate, and an additive having self-selective characteristics. The ball-milling methods, such as mixing dispersants with the above mentioned compounds then ball-milling, are well known within in the field. One or more common dispersants may be used including methanol, ethanol, and acetone.

When sintering, in order to ensure complete reaction of the lithium compounds, phosphorous compounds and ferrous oxalate, particle formation preferably takes place after the ball-milled mixture has been dried. Particle formation methods and conditions are well known within the field.

Sintering methods and conditions are well known within the field. Sintering is commonly a two stage process, the goal during the first stage being to allow large particles of ferrous oxalate to decompose into small particles, then in the second stage to produce lithium ferrous phosphate crystals. Under normal conditions, the first sage of sintering is done at 300-500° C., preferably 350-450° C., for a period of 4-10 hours, preferably 6-8 hours. The second stage of sintering is done at 600-800° C., preferably 650-750° C., for a period of 8-30 hours, preferably 12-20 hours. During a two stage sintering process in order to achieve lithium ferrous phosphate particles of evenly distributed size, it is preferable to grind the products of the first stage before the second stage is begun. Grinding may be done by way of the ball milling process described above, which will not be further described here.

According to the present invention, because the ferrous oxalate used in the present invention is produced by the methods described above and has small and evenly distributed particle size, during mixing the ferrous oxalate mixes evenly with other ingredients. During high temperature solid phase reactions the distances between the various kinds of ions shrink due to solid phase diffusion. Because of this, one phase of sintering is sufficient to produce the desired results. The sintering temperature during this phase is 650-850° C., preferably 700-800° C., and the sintering time is 8-40 hours, preferably 10-20 hours.

To prevent oxidation of ferrous oxalate during the sintering process, sintering is preferably done in an inert or reduction atmosphere. Inert or reduction atmosphere refers to a gas or gaseous compound mixture that does not react with the reactants or products, including one or more of the following: hydrogen, nitrogen, carbon monoxide, ammonia decomposed gas or a noble gas. This inert or reduction atmosphere can be static, or preferably, have a gas flow of 2-50 liters/minute.

The present invention is described below using specific examples.

### Embodiment 21

This embodiment illustrates the methods provided in the present invention of preparing ferrous oxalate and producing lithium ferrous phosphate from ferrous oxalate.

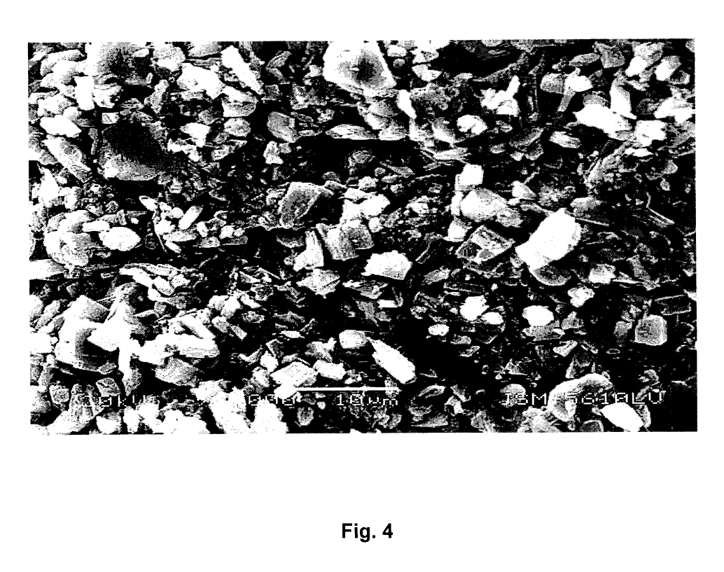

(1) Dissolve 10 moles/liter ferrous sulfate heptahydrate in de-ionized water to form an aqueous ferrous sulfate solution with iron ion concentration of 1 mole/liter. Dissolve 10 moles of kalium oxalate in deionized water to form a kalium oxalate solution with oxalic acid ion concentration of 1 mole/liter. Pour 6 liters of deionized water into a 30 liter reaction vessel. Then use a metering pump to pump a homogeneous flow of ferrous sulfate into the vessel, while at the same time using a servo pump to pump a homogeneous flow of the above mentioned kalium oxalate into the vessel. The flow rate of the ferrite liquid solution is 2 liters/hour. The flow rate of the oxalate gives the resulting slurry a pH of 3. Stop the reaction 5 hours after it starts, and allow the slurry in the reaction vessel to age for 4 hours. Next filter out the solids and rinse them with water 3 times, then wash with ethanol one time. Completely rinse the solution off the solids then filter and dry for 5 hours in a vacuum at 80° C. to produce ferrous oxalate with a median particle diameter D50 of 2 microns. An SEM image of this ferrous oxalate taken with a Japanese company (Shimadzu) manufactured SSX-550 scanning electron microscope is shown in FIG. 4. (

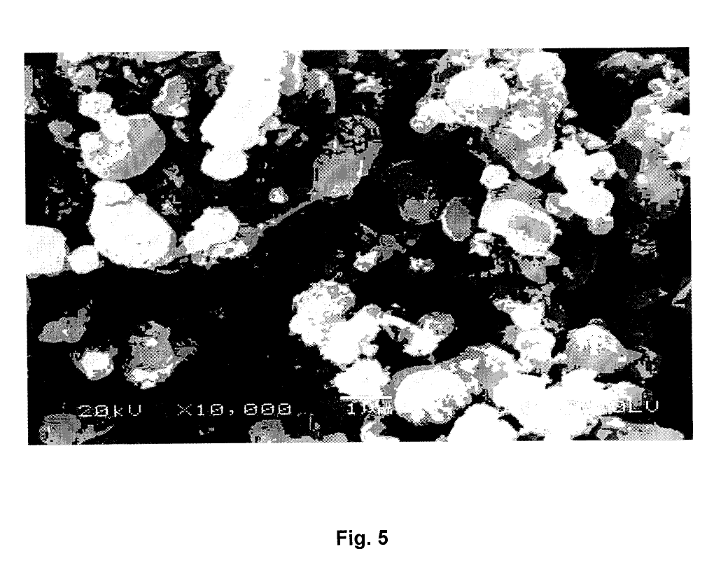

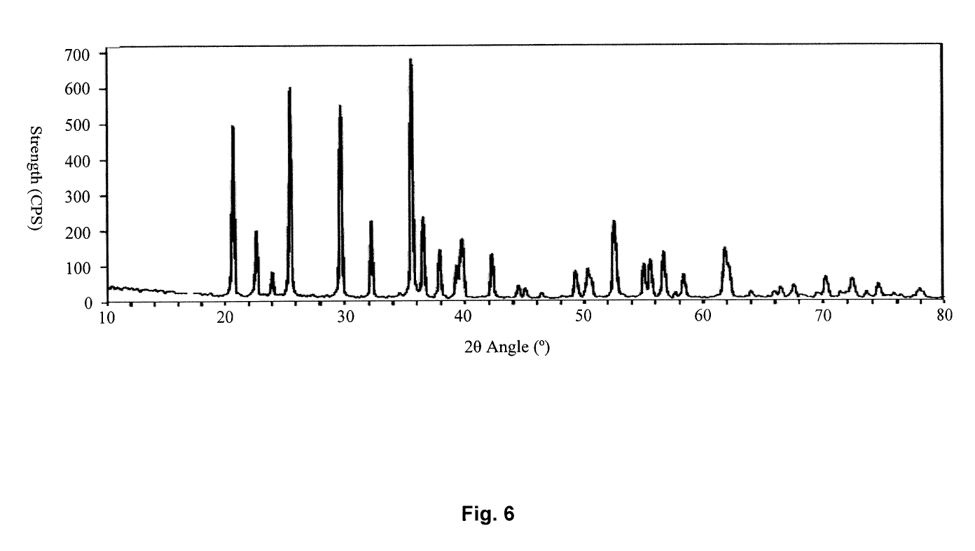

2) Using the Li:Fe:P ratio of 1:1:1, weigh out 370 grams of lithium carbonate, 1799 g of the ferrous oxalate obtained in step (1), and 1150 g of ammonium dihydrogen phosphate. Using the C:Fe ratio of 0.5, add 165 g of sucrose as a carbon source. Place the above mentioned lithium carbonate, ferrous oxalate, ammonium dihydrogen phosphate and sucrose in a ball-mill, and add 5000 ml anhydrous ethanol as a dispersant. Mill for 0.5 hours. Use a spray granulator to dry and granulate the resulting mixture. Place the powder described above into a corundum pot and sinter in a high temperature oven with an argon atmosphere flowing at 20 liters/minute. Sintering temperature is 700° C., and sintering time 20 hours. When the powder cools off a jet pulverizer is used to obtain lithium ferrous phosphate particles. A SEM of this lithium ferrous phosphate taken with a Shimadzu SSX-550 scanning electron microscope is shown in FIG. 5. A powder diffraction pattern made with a Rigaku D/MAX-2200/PC X-ray diffractometer is shown in FIG. 6.

### Embodiment 22

This example illustrates the methods provided in the present invention of preparing ferrous oxalate and producing lithium ferrous phosphate from ferrous oxalate.

Ferrous oxalate and lithium ferrous phosphate are produced according to embodiment 21, the difference being the when preparing ferrous oxalate, the oxalate solution is made from 10 moles sodium oxalate mixed with water to form a solution with oxalic acid ion concentration of 1 mole/liter. The flow rate of the ferrite liquid solution is 3.5 liters/hour, and the flow rate of the oxalate liquid solution gives the resulting slurry a pH of 4. The result is ferrous oxalate dihydrate with a median diameter D50 of 2.5 microns.

### Embodiment 23

This embodiment illustrates the methods provided in the present invention of preparing ferrous oxalate and producing lithium ferrous phosphate from ferrous oxalate.

Ferrous oxalate and lithium ferrous phosphate are produced according to embodiment 21, the difference being when preparing ferrous oxalate, 10 moles of ferrous sulfate are mixed with water to form a solution with iron ion concentration of 0.5 moles/liter. 10 moles of sodium oxalate are mixed with water to form a solution with oxalic acid ion concentration of 0.5 moles/liter. The flow rate of the ferrite liquid solution is 5 liters/hour, and the flow rate of the oxalate liquid solution gives the resulting slurry a pH of 3.5. The result is ferrous oxalate dihydrate with a median diameter D50 of 2.2 microns

When preparing the lithium ferrous phosphate, the difference is that 175 g of citric acid is used as the carbon source, maintaining the C:Fe molar ratio at 0.5. When sintering, the sintering temperature is 800° C. and the sintering time is 15 hours.

### Embodiment 24

This embodiment illustrates the methods provided in the present invention of preparing ferrous oxalate and producing lithium ferrous phosphate from ferrous oxalate.

Ferrous oxalate and lithium ferrous phosphate are produced according to embodiment 21, the difference being that when preparing ferrous oxalate, 10 moles of ferrous chloride are mixed with water to form a solution with iron ion concentration of 1 moles/liter; and 5 moles of sodium oxalate and 5 moles of sodium oxalate are mixed with water to form a solution with oxalic acid ion concentration of 1 moles/liter. The flow rate of the ferrite liquid solution is 1 liter/hour, and the flow rate of the oxalate liquid solution gives the resulting slurry a pH of 2. The result is ferrous oxalate dihydrate with a median diameter D50 of 1.5 microns

When preparing the lithium ferrous phosphate, the difference is that 831.2 g lithium dihydrogen phosphate and 1439.2 g ferrous oxalate obtained from step one are used in keeping with the Li:Fe:P molar ratio of 1:1:1, and 114.1 g of sucrose is used as the carbon source, in keeping with the C:Fe ratio of 0.5.

### Embodiment 25

This embodiment illustrates the methods provided in the present invention of preparing ferrous oxalate and producing lithium ferrous phosphate from ferrous oxalate.

Ferrous oxalate and lithium ferrous phosphate are prepared according to the methods in embodiment 24, the difference being that when preparing the lithium ferrous phosphate, a two stage sintering process is used. First the mixed powder particles are sintered in a high temperature oven with an argon atmosphere moving at 20 liters/minute. Sintering temperature is 350° C. and sintering time is 8 hours. After the powder has cooled it is milled in a ball-mill for 0.5 hours, then again placed in a corundum pot and into a high temperature oven with an argon atmosphere moving at 20 liters/minute for a second stage of sintering. Sintering temperature is 750° C. and sintering time is 20 hours. When the powder has cooled it undergoes jet pulverization to obtain lithium ferrous phosphate particles.

### Comparative Embodiment 21

This comparative embodiment illustrates the preparation of ferrous oxalate and the preparation of lithium ferrous phosphate from ferrous oxalate to serve as a reference

According to the publicly known method for preparing ferrous oxalate given in Effect of Reaction Time on the Composition of Ferrous Oxalate (Sun Yue and Qiao Qingdong; Journal of Liaoning University of Petroleum, Volume 25 No. 4), 18 g of ferrous ammonium sulfate are mixed with 90 ml of distilled water to obtain an aqueous ferrous ammonium sulfate solution. Then 6 ml of 2 mole/liter sulfuric acid solution is added to acidify the solution, which is heated to dissolve. Next 120 ml of 1 mole/liter oxalate solution is added to the above solution, and the resulting solution is heated for 80 minutes while being mixed. The solution is allowed to stand, the clear liquid is poured off, and the yellow precipitate is washed with water, filtered, and dried. The result is ferrous oxalate dihydrate with median particle diameter D50 of 11 microns.

A method similar to that described in embodiment 21 is used to prepare lithium ferrous phosphate, the difference being that the ferrous oxalate is prepared according to the methods given in the comparative embodiment above.

### Comparative Embodiment 22

This comparative embodiment illustrates the preparation of ferrous oxalate and the preparation of lithium ferrous phosphate from ferrous oxalate to serve as a reference

Ferrous oxalate and lithium ferrous phosphate are prepared according to embodiment 21, the difference being that the flow rate of the ferrite is 5 liters/hour, and the flow rate of the oxalate liquid solution gives the resulting slurry a pH of 1. The reaction is stopped after 2 hours, and no aging is done. The results are filtered and the solids are washed and dried for 5 hours in a vacuum at 80° C. to produce ferrous oxalate dihydrate with median particle diameter D50 of 15 microns.

### Comparative Embodiment 23

This comparative embodiment illustrates the preparation of ferrous oxalate and the preparation of lithium ferrous phosphate from ferrous oxalate to serve as a reference.

Ferrous oxalate and lithium ferrous phosphate is prepared according to embodiment 21, the difference being that the flow rates of the ferrite liquid solution and oxalate gives the resulting slurry a pH of 8. The reaction is stopped after 5 hours, and the results are aged and filtered. The solids are then rinsed and dried for 5 hours in a vacuum at 80° C. to produce ferrous oxalate dihydrate with median particle diameter D50 of 13 microns.

### Embodiments 26-30

The embodiments below illustrate tested properties of batteries made using lithium ferrous phosphate prepared according to the present invention as a positive electrode active substance.

### (1) Battery Preparation

### Positive Electrode Preparation

Mix 100 g of positive electrode active ingredient LiFePO4 as prepared in embodiments 21-25, 3 g of adhesive PVDF, and 2 g of conductive agent acetylene black into 50 g of n-methyl-2-pyrrolidone. Then mix in a vacuum mixer to form homogenous positive electrode substance.

Evenly paste this positive electrode substance onto both sides of 20 micron thick aluminum foil, so that single surface density is 12mg/cm2. Heat dry at 150° C., roll, and cut a 540×43.5 mm positive electrode containing 5.63 g of active substance LiFePO4.

### Negative Electrode Preparation

Combine 100 g of negative electrode active ingredient natural graphite, 3 g of adhesive PVDF, and 3 g of conductive material carbon black into 100 g n-methyl-2-pyrrolidone, and mix in a vacuum to create the negative electrode material.

Evenly paste this negative electrode substance onto both sides of 12 micron thick copper foil, so that single surface density is 5 mg/cm2. Heat dry at 90° C., roll, and cut a 500×44 mm negative electrode containing 2.6 g of active substance natural graphite.

### Battery Assembly

Wind the positive and negative electrodes and the polypropylene membrane into a rectangle-shaped lithium ion battery core, then dissolve 1 mole/liter LiPF6 in a EC/EMC/DEC=1:1:1 solvent mixture to produce an non-aqueous electrolyte solution. Pour 3.8 g/Ah of this electrolyte solution into the battery's aluminum shell and seal to create lithium ion secondary batteries A1-A5.

### Testing of Battery Properties

Lithium ion batteries A1-A5 described above are placed in a testing cabinet and charged using 15 milliamp/hour constant current and constant voltages for 2.5 hours. Maximum charge is 3.85 volts. After allowing the batteries to sit for 20 minutes they are discharged at a rate of 15 mAh/g from 3.85 to 2.5 volts. The first discharge capacity of each battery is recorded and the above described cycle is repeated 20 times. The discharge capacity is then recorded again, and the following formulae are used to compute the specific energy and battery charge retention:

Specific energy=first discharge capacity (mAh)/positive electrode substance mass (g)

Charge retention=(discharge capacity after 20 cycles/first discharge capacity)×100%

The results are given in Table 2.

### Comparative Embodiments 24-26

The following comparative embodiments illustrate properties testing of batteries made with reference positive electrode active substance lithium ferrous phosphate.

Batteries AC1-AC3 are prepared according to embodiments 26-30 and the batteries initial discharge capacity and cycling properties are tested. In addition the batteries specific energy is tested before and after cycling, the difference being that the positive electrode active substance is the lithium ferrous phosphate obtained in comparative embodiments 21-23.

The results are given in Table 2 below.

TABLE 2

| | | Initial | | |
|---|---|---|---|---|
| | | Discharge | Specific | |
| | | Specific | Energy after | Charge |
| Embodiment | Battery | Energy | 20 Cycles | Retention |
| No. | No. | (mAh/g) | (mAh/g) | (%) |
| Embodiment | A1 | 143.2 | 142.5 | 99.5 |
| 26 | | | | |
| Comp. | AC1 | 130.1 | 117.1 | 90.0 |
| Embodiment | | | | |
| 24 | | | | |
| Comp. | AC2 | 132.6 | 115.7 | 87.3 |
| Embodiment | | | | |
| 25 | | | | |
| Comp. | AC3 | 127.2 | 118.8 | 93.4 |
| Embodiment | | | | |
| 26 | | | | |
| Embodiment | A2 | 141.6 | 140.2 | 99.0 |
| 27 | | | | |
| Embodiment | A3 | 139.5 | 138.9 | 99.6 |
| 28 | | | | |
| Embodiment | A4 | 137.7 | 135.8 | 98.6 |
| 29 | | | | |
| Embodiment | A5 | 145.8 | 143.0 | 98.1 |
| 30 | | | | |

Using the method of embodiment 21 as an example, FIG. 4 is a 5,000× magnification scanning electron microscope image of ferrous oxalate prepared according to the methods of the present invention. The image shows that the ferrous oxalate crystal particles have homogeneous particle size, evenly distributed diameters, and that most diameters are in the 1-3 micron range.

FIG. 5 is a 10,000 magnification SEM image of lithium ferrous phosphate made with ferrous oxalate prepared according to the methods of the present invention. Said lithium ferrous phosphate particles have small diameters and homogenous particle size, with most diameters between 0.5 and 1.5 microns.

FIG. 6 shows that the above described lithium ferrous phosphate has standard chrysolite structure.

The data in Table 2 shows that compared to reference batteries made using lithium ferrous phosphate prepared with ferrous oxalate from current methods, batteries whose lithium ferrous phosphate is made from ferrous oxalate prepared according to the methods of the present invention have significantly higher specific energies both on initial discharge and performance after 20 cycles. These batteries also have charge retention of 98% or more after 20 cycles, indicating that these batteries posses favorable features, and indicating that the positive electrode substance in the present invention has superior electrochemical properties.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for preparing lithium ferrous phosphate, comprising the steps of:
flowing a ferrite solution with an oxalate solution, wherein the flow speed of the ferrite solution and the flow speed of the oxalate solution results in a slurry having a pH of 3-6;
mixing and drying said slurry to obtain ferrous oxalate; and
mixing and sintering one or more lithium compounds, one or more phosphorous compounds, and the ferrous oxalate to produce lithium ferrous phosphate.

2. The method of claim 1, wherein the flow rate of the ferrite solution is 1-10 liters/hour, with the flow rate of the oxalate solution, the slurry produced has a pH of 3-6.

3. The method of claim 1, wherein the ferrite solution and oxalate solution have an even flow rate.

4. The method of claim 1, during the flowing step, the ferrite solution and oxalate solution are brought in contact and the resulting solution flows into water.

5. The method of claim 1, wherein the ferrite solution is an aqueous solution having an iron ion concentration of 0.1-5 moles/liter; wherein the ferrite of the ferrite solution is selected from one or more of the following: ferrous sulfate, ferrous chloride, or ferrous acetate; wherein the oxalate solution is an aqueous solution having an oxalic acid ion concentration of 0.1-5 moles/liter; wherein the oxalate of the oxalate solution is selected from one or more of the following: sodium oxalate, kalium oxalate, ammonium oxalate, or lithium oxalate.

6. The method of claim 1, wherein the slurry is aged at a temperature of 40-90° C. for 1-10 hours.

7. The method of claim 1, wherein the ferrite solution containing ferrous salts and soluble non-iron metal salts, the flow rates of said solutions cause the resulting slurry to have a pH of 3-6; wherein said soluble non-iron metal salts is selected from one or more soluble salts of group IIA metals, group IIIA metals, group IVA metals, group IB metals, group IIB metals, group IIIB metals, group IVB metals, group VB metals, group VIB metals, group VIIB metals, and non-iron group VIII metals.

8. The method of claim 7, wherein said ferrite solution containing ferrous salts and soluble non-iron metal salts and the oxalate solution are both aqueous solutions; wherein the ferrous salts is selected from among one or more of ferrous sulfate, ferrous chloride, and ferrous acetate; wherein the soluble non-iron metal salts are selected from one or more soluble sulfate, nitrates, or chlorides of group IIA metals, group IIIA metals, group IVA metals, group IB metals, group IIB metals, group IIIB metals, group IVB metals, group VB metals, group VIB metals, group VIIB metals, or group VIII non ferrous metals; and wherein the oxalate of the oxalate solution is selected from among one or more of sodium oxalate, kalium oxalate, ammonium oxalate, or lithium oxalate.

9. The method of claim 8, wherein the soluble non-iron metal salts are selected from among one or more of magnesium sulfate, aluminum sulfate, zirconium nitrate, manganese sulfate, cobalt sulfate, nickel sulfate, zinc sulfate, magnesium nitrate, aluminum nitrate, magnesium chloride, aluminum chloride, manganous chloride, cobaltous chloride, nickelous chloride, calcium chloride, barium chloride, strontium chloride, stannous chloride, or lanthanum nitrate.

10. The method of claim 7, wherein said ferrite solution containing ferrous salts and soluble non-iron metal salts has an overall ferrous ion and soluble non-iron metal salt ion concentration of 0.5-5 moles/liter and in the ferrite solution the molar ratio of ferrous ions and non-iron metal ions is 1:0.005-0.25; and the concentration of oxalate ions in said oxalate solution is 0.1-5 moles/liter.

11. A method for preparing lithium ferrous phosphate, comprising the steps of:
flowing a ferrite solution with an oxalate solution, wherein the flow speed of the ferrite solution and the flow speed of the oxalate solution results in a slurry having a pH of 3-6; wherein the ferrite solution containing ferrite and soluble non-iron metal salts; wherein said soluble non-iron metal salts is selected from one or more soluble salts of group IIA metals, group IIIA metals, group IVA metals, group IB metals, group IIB metals, group IIIB metals, group IVB metals, group VB metals, group VIB metals, group VIIB metals, and non-iron group VIII metals;
mixing and drying said slurry to obtain ferrous oxalate; and
mixing and sintering one or more lithium compounds, one or more phosphorous compounds, and the ferrous oxalate to produce lithium ferrous phosphate.

12. The method of claim 11, wherein said ferrite liquid solution containing ferrous salts and soluble non-iron metal salts has a flow rate of 1-10 liters/hour, with the flow rate of said oxalate solution, the resulting slurry produced has a pH of 3-6.

13. The method of claim 11, wherein the flow rates of the ferrite solution containing ferrous salts and soluble non-iron metal salts and the oxalate solution are even.

14. The method of claim 11, wherein said ferrite liquid solution containing ferrous salts and soluble non-iron metal salts and the oxalate solution are brought in contact during mixing and simultaneously enter into water.

15. The method of claim 14, wherein said ferrite solution containing ferrous salts and soluble non-iron metal salts and the oxalate solution are both aqueous solutions; wherein the ferrite of the ferrite solution is selected from among one or more of ferrous sulfate, ferrous chloride, and ferrous acetate; wherein the soluble non-iron metal salts are selected from one or more soluble sulfate, nitrates, or chlorides of group IIA metals, group IIIA metals, group IVA metals, group IB metals, group IIB metals, group IIIB metals, group IVB metals, group VB metals, group VIB metals, group VIIB metals, or group VIII non ferrous metals; and wherein the oxalate of the oxalate solution is selected from among one or more of sodium oxalate, kalium oxalate, ammonium oxalate, or lithium oxalate.

16. The method of claim 15, wherein the soluble non-iron metal salts are selected from among one or more of magnesium sulfate, aluminum sulfate, zirconium nitrate, manganese sulfate, cobalt sulfate, nickel sulfate, zinc sulfate, magnesium nitrate, aluminum nitrate, magnesium chloride, aluminum chloride, manganous chloride, cobaltous chloride, nickelous chloride, calcium chloride, barium chloride, strontium chloride, stannous chloride, or lanthanum nitrate.

17. The method of claim 11, wherein said ferrite solution containing ferrous salts and soluble non-iron metal salts has an overall ferrous ion and soluble non-iron metal salt ion concentration of 0.5-5 moles/liter and in the ferrite solution the molar ratio of ferrous ions and non-iron metal ions is 1:0.005-0.25; and the concentration of oxalate ions in said oxalate solution is 0.1-5 moles/liter.

18. The method of claim 11, wherein the lithium source is selected from among one or more of LiOH, Li₂CO₃, CH₃COOLi, LiNO₃, Li₃PO₄, Li₂HPO₄, and LiH₂PO₄; said phosphorous source is selected from among one or more of (NH₄)₃PO₄, (NH₄)₂HPO₄, NH₄H₂PO₄, Li₃PO₄, Li₂HPO₄, and LiH₂PO₄; said lithium source, phosphorous source, and iron source are used in amounts such that the lithium:iron and non-iron metal:phosphorous molar ratio is (1-1.07): 1:1.

19. A method for preparing lithium ferrous phosphate, comprising the steps of:
flowing a ferrite solution with an oxalate solution into water, wherein the flow speed of the ferrite solution and the flow speed of the oxalate solution results in a slurry having a pH of 3-6, and wherein the slurry is aged at a temperature of 40-90° C. for 1-10 hours;
mixing and drying said slurry to obtain ferrous oxalate; and
mixing and sintering one or more lithium compounds, one or more phosphorous compounds, and the ferrous oxalate to produce lithium ferrous phosphate;
wherein said ferrite solution containing ferrous salts and soluble non-iron metal salts and the oxalate solution are both aqueous solutions; wherein the ferrite of the ferrite solution is selected from among one or more of ferrous sulfate, ferrous chloride, and ferrous acetate; wherein the soluble non-iron metal salts are selected from one or more soluble sulfate, nitrates, or chlorides of group IIA metals, group IIIA metals, group IVA metals, group IB metals, group IIB metals, group IIIB metals, group IVB metals, group VB metals, group VIB metals, group VIIB metals, or group VIII non ferrous metals; and wherein the oxalate of the oxalate solution is selected from among one or more of sodium oxalate, kalium oxalate, ammonium oxalate, or lithium oxalate; wherein the soluble non-iron metal salts are selected from among one or more of magnesium sulfate, aluminum sulfate, zirconium nitrate, manganese sulfate, cobalt sulfate, nickel sulfate, zinc sulfate, magnesium nitrate, aluminum nitrate, magnesium chloride, aluminum chloride, manganous chloride, cobaltous chloride, nickelous chloride, calcium chloride, barium chloride, strontium chloride, stannous chloride, or lanthanum nitrate; and
wherein said ferrite solution containing ferrous salts and soluble non-iron metal salts has an overall ferrous ion and soluble non-iron metal salt ion concentration of 0.5-5 moles/liter and in the ferrite solution the molar ratio of ferrous ions and non-iron metal ions is 1:0.005-0.25; and the concentration of oxalate ions in said oxalate solution is 0.1-5 moles/liter.

20. The method of claim 19, wherein said ferrite liquid solution containing non-ferrous and soluble non-iron metal salts has a flow rate of 1-10 liters/hour, with the flow rate of said oxalate solution, the resulting slurry produced has a pH of 3-6.
